(19) United States
(12) Patent Application Publication
(10) Pub. No.: US 2019/0350173 A1
(43) Pub. Date: Nov. 21, 2019

(54) EGGOIST MULTI-LEVEL SYSTEM OF FLOOR EQUIPMENT FOR COMMERCIAL POULTRY MAINTENANCE

(71) Applicant: TEXHA PRODUCTION ASSOCIATION, LIMITED LIABILITY COMPANY, Novograd-Volyinskiy (UA)

(72) Inventors: Sergii Bondarev, Kyiv (UA); Gennadii Malovanyi, Kharkiv (UA); Tetyana Grygorenko, Kyiv (UA); Oleksandr Lystopadov, Kyiv region (UA)

(21) Appl. No.: 16/031,282

(22) Filed: Jul. 10, 2018

(30) Foreign Application Priority Data
May 15, 2018 (UA) A201805319UA

(51) Int. Cl. A01K 31/22; A01K 31/16

(52) U.S. Cl. CPC A01K 31/22; A01K 31/165

(57) ABSTRACT

EGGOIST multi-level floor equipment system for commercial poultry maintenance combining the advantages of poultry's free-range run with periodical automated manure removal feature of the cage housing method. The optimum dimensions of the aviary body frame are calculated as per special formulae for the length and width depending on the nest type and arrangement. EGGOIST equipment system allows to improve the microclimate parameters of the aviary, to ensure the consistently high sanitary and hygienic conditions and the lowering of egg-laying hens' morbidity rate, and to dramatically increase production rates per farmland area unit.

This application claims priority to Ukrainian application a201805319UA, which was filed on 15 May 2018, and which is herein incorporated by reference.

### BACKGROUND OF THE INVENTION

### Field of the Invention

The invention relates to aviculture, in particular to equipment for commercial poultry maintenance comprising automated systems for poultry life support, egg collection and manure removal.

### Description of the Background Art

At present, commercial poultry production widely uses cages for housing laying hens, when birds is constantly kept in battery cages, e.g. in tiered cages or runs equipped with feeding and drinking appliances, manure removal, heating and ventilating devices. A battery cage for housing egg-laying hen breeds contains nesting areas where eggs are laid. Eggs are carried by a conveyor from the nesting area to an egg collection area where they are further processed and prepared for transporting. Manure removal in battery cages is usually provided by a built-in transporter, whose belt is positioned below the mesh floor of each of the tiers formed by the cages (patent UA 114210 U, Lystopadov A.S.). Numerous variations of this method are also known, with movement of withdrawable floor elements in cages and use of scrapers for discarding manure onto the transporter (e.g., patent RU 78630 U1, Vorontsov A. N., Mazurov V.V., Bondarenko A.A.). The cage method of housing hens is characterized by a high degree of mechanization of all poultry life support elements: a system for preparation of water and drinking, automated feeding, automated egg collection, regulated microclimate and lighting regime corresponding to the poultry's physiological needs.

However, housing poultry in cages is characterized by a high cage density, which substantially limits the bird's ability to move. This leads to deterioration of its condition, increases in morbidity and reduces its productive lifespan. Multi-tier cage constructions are also the cause of increased rate of poultry injuries, including while conducting technological operations. Among the disadvantages of caging poultry is also the necessity to have sufficiently wide service walkways between cages on one tier and to use manual labor for cleaning.

Different ways to improve the cage method of poultry housing are known: the use of so called alternative systems, such as “enriched cages”, “furnished cages”, as well as the use of caging poultry with poultry run (BALTIKA equipment of TEXHA Production Association, Magnum equipment of FACCO Company, NATURA equipment of Big Dutchman Company). In this case the equipment of an aviary may have up to three or four tiers. Considering that floors in cages (aviaries) are meshed, manure from upper tiers partially falls onto the poultry on lower tiers, and the poultry's movement from one tier to another increases its injury and mortality rate. Generally, most efforts in the direction of improving the cage method of poultry housing are focused on the enhancement of housing conditions by forced change of the gas-air mixture composition in the aviary, special lighting regime, treatment of the aviary interior with disinfectants, as well as feed and water supplementation with veterinary medicinal products, vitamins and other nutritious additives.

The opposite of cage housing is a floor, or cage free (free range), method of poultry maintenance, which is used in different variations, including with free-range run outside the aviary. This technology provides the closest environment to the natural hens' behavior and is considered the most beneficial for poultry welfare. Under this method, poultry is kept in special enclosures—aviaries, runs with solid floor covering and a litter of naturally occurring materials (straw, wood chips, sawdust). Thus, the possibility to satisfy the poultry's natural physiological needs—to freely walk, peck and scratch the litter—is provided. The non-use of cages allows the hens to lead a more normal life. This method is actively used on farms.

However, the non-use of cages and free-range run of poultry on a relatively large territory leads to practically all of the territory being intensively contaminated. The poultry's waste products—manure, feed leftovers, moisture, feathers etc.—are deposited on the litter. Such mixture constantly ferments and putrefies, releasing carbon dioxide, methane, ammonia and other air pollutants; dust content and general humidity level in the aviary increase. Carbon dioxide accumulation in the air irritates mucous membrane and skin, causes acidosis and inhibits breathing; if the critical CO2 level is exceeded, poultry mortality caused by respiratory arrest is possible. Ammonia produced when manure and litter material decompose stimulates the transformation of blood hemoglobin into alkaline hematin, whereby poultry develops anemia. Ammonia content exceeding 15 mg/m3 causes poultry kill. Once in blood circulation, hydrogen sulfide binds hemoglobin iron, whereby oxidative reactions are interrupted and poultry suffers from hypo-oxygenation. Besides, litter on a solid floor is an ideal medium for pathogenic bacteria growth. On a commercial scale, manure and other waste removal in the floor method of poultry housing takes place at the stage of flock depopulation, i.e. at the end of its life cycle, therefore during the whole of their productive life period hens remain in contact with ever more contaminated litter. This increases the probability of poultry catching infectious diseases and affects the microclimate in the aviary. Removing diseased or dead poultry from the aviary requires manual labor. Therefore, to maintain satisfactory hygiene and sanitary conditions in the aviary throughout a usual production cycle of floor housing, the use of antibiotics, forced ventilation and periodical inspections are necessary. All this requires an increase of the proportion of manual labor and energy consumption and has a negative effect on the product's prime cost and quality.

Additionally, free movement of the poultry in open or relatively open space leads to occurrence of the possibility of some number of eggs being laid outside the nesting area, and these eggs remain unattended until operating personnel inspects the aviary and collects the eggs laid outside the nests. As a result, a certain amount of produce is lost. Moreover, the eggs collected in open areas of the aviary may be infested by bacteria and helminthes due to having been resting in manure for several days. Such eggs are unfit for human consumption, which results to their lower price.

Thus, the widely used methods of commercial poultry management have, besides undeniable advantages, major drawbacks. Therefore, numerous researches and developments have been undertaken lately to improve the commercial poultry housing conditions and, without a substantial increase of prime cost, attain the production of consistently high quality produce which meets the standards of international institutions and professional associations in the poultry farming sphere, as well as the requirements of environmental and animal rights organizations.

The present invention responds to the needs of the poultry farming market, with the view of the requirements set by the industry standards. When solving these problems, the the present invention complies with guidance from the EU Council Directive 98/58/EC of 20 Jul. 1998 concerning the protection of animals kept for farming purposes, which, among other things, concerns the conditions of housing laying hens, and EU Council Directive 1999/74/EC of 19 Jul. 1999 laying down minimum standards for the protection of laying hens, which, among other things, prescribes the conditions for egg-laying chicken breeds in alternative housing systems.

The technical problem of the claimed invention is designed to solve consists of modifying the floor method of poultry maintenance with the purpose of intensifying egg production while maintaining or improving their quality and ensuring consistently high sanitary and hygienic housing conditions of egg-laying hens under the EU standards, as well as lowering the bird morbidity rate.

### SUMMARY OF THE INVENTION

The objective of the present invention is achieved by using, for commercial maintaining of poultry, of EGGOIST multi-level system of floor equipment combining the conditions for poultry's free-range run with periodical mechanized manure removal characteristic of the cage housing method.

U.S. patent application Ser. No. 14/071,160 of Nov. 4, 2013, “Aviary cage with egg and manure removal system and method for constructing same”, published on May 7, 2015, US 2015/0122191 A1, was taken as a prototype.

EGGOIST multi-layer equipment system differs essentially from other cage-free poultry maintenance systems in that the solid floor covering is replaced by a meshed one, and a system of manure removal with the help of a transporter whose belt is positioned below the level of the mesh floor is added to the available life support systems. The transporter belt of the upper level serves as the ceiling of the lower level, and the guides for transporter belts serve as bearing members of the aviary construction as a whole.

Due to the fact that the floor on each level is meshed, the need to use the regular litter no longer exists. The manure dropped by the poultry does not get onto the solid covering, but is trampled by the hens through the mesh and dropped on the manure belt. Thus, poultry's long-term contact with manure is almost completely excluded. The poultry's waste products can be removed from the aviary with any required frequency, as a rule daily, while there is no need to move the birds anywhere for the time of cleaning. The absence in the floor plane of mechanical details moving during cleaning in the direction perpendicular to the transporter belt movement reduces the risk of bird injury. Service walkways within one level may be brought out to the perimeter of the aviary guards and substantially narrowed or obviated altogether, as, in contrast to battery cages, there is no need to pull the moving parts of the cage floor into the walkways in the EGGOIST system. The minimization of service walkways allows using the overall level area more intensively.

To meet the poultry's natural physiological needs, 15 to 30% of the total floor area on each level is covered by solid covering forming the natural fitter area, which allows to maximally bring the poultry housing conditions to the natural habitat. When the floor method of housing laying hens is used, 1 square meter of litter emits up to 25 mg of ammonia, 15 mg of hydrogen sulfide and 8 mg of carbon dioxide per hour. Control measurements in the aviary fitted with EGGOIST multilevel floor equipment system (manufacturing and experimental plot of TEXHA Production Association, Novohrad-Volynsky, Zhytomyr region) showed that gas emission per 1 square meter of the area is reduced to 8 mg of ammonia, 5 mg ofhydrogen sulfide and 5 mg of carbon dioxide per hour, i.e. by a factor of two to three. The substantial reduction of the content of harmful impurities in the air reduces the probability of infecting the birds and allows to fully or partially discontinuing the use of antibiotics and other veterinary preparations. Minimizing the poultry's contact with manure decreases the risk of helminthes infestation. On the whole, the microclimate in an aviary equipped with EGGOIST equipment system improves noticeably and may be sustained within the parameters optimal for healthy poultry housing: stable temperature, humidity 60 to 70%, dust content not exceeding 8%, carbon dioxide content in air ≤0.25%, ammonia content ≤15 mg/m³.

Due to the presence of a natural fitter area in the EGGOIST equipment system and the improvement of the aviary microclimate as a whole, the poultry has more freedom to move, which excludes the development of hypodynamia, strengthens the birds' skeleton and muscular system, exercises their wings and conduces to strengthening of the immune system. The injury and mortality levels of the poultry decreases, as the hens have no possibility to move from one level to another, which is the case in multi-level battery cages. The healthy housing conditions of the poultry increase its egg-laying capacity.

Generally EGGOIST system is fitted with the equipment for rest (perches), drinking and feeding of laying hens, egg collection and transportation, energy supply, ventilation and other equipment.

The use of EGGOIST multi-level floor equipment system implies observance of the following parameters:

1) The floor area in the main housing zone per bird is not less than 930 cm² (exact minimum value is 929.0304 cm², which equals 1 square foot in the English engineering units).

2) Between 15 and 30% of the floor area is allocated for the zone of the birds' natural needs, namely “litter bathing”.

3) The nests have the area not less than 8370 cm² (exact minimum value is 8361.2736 cm², which equals 9 square foot) per 100 birds.

4) All the facilities in the aviary have a level of illumination sufficient for the hens to see each other clearly, visually orientate themselves in space and live an ordinary life.

5) The light regime which includes an uninterrupted darkness period not less than 8 hours, ensures that the birds get the necessary rest, allowing to avoid such problems as decreased immunity and ocular anomalies, when hens peck each other to death. The twilight period (sunrise-sunset) of the necessary duration is imitated by dim illumination, which allows hens to perching or come down without agitation and injuries.

6) Feeder and drinking space conforms with the regulatory requirements.

7) The equipment parts with which the birds come into contact are washed and disinfected regularly.

8) Manure is removed daily.

9) The possibility to check the hens' movement is provided.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1—arrangement of a single level in the aviary fitted with EGGOIST equipment system, top view.

FIG. 2—longitudinal section of the aviary, section AA.

FIG. 3—cross-section of the aviary, section BB.

FIG. 4—diagram of the mutual arrangement of the main poultry housing area, natural needs zone and the longitudinal service zone.

FIG. 5—diagram of trampling down of manure by birds in the main housing area.

FIG. 6—cross-section of a double nest.

FIG. 7—cross-section of a single nest.

FIG. 8—boundary between the main poultry housing area and the natural needs zone, general view.

FIG. 9—fragment of an aviary fitted with EGGOIST equipment system, general view.

FIG. 10—diagram of the rates of infestation of laying hens by helminthes when using various systems for poultry maintenance.

### DETAILED DESCRIPTION

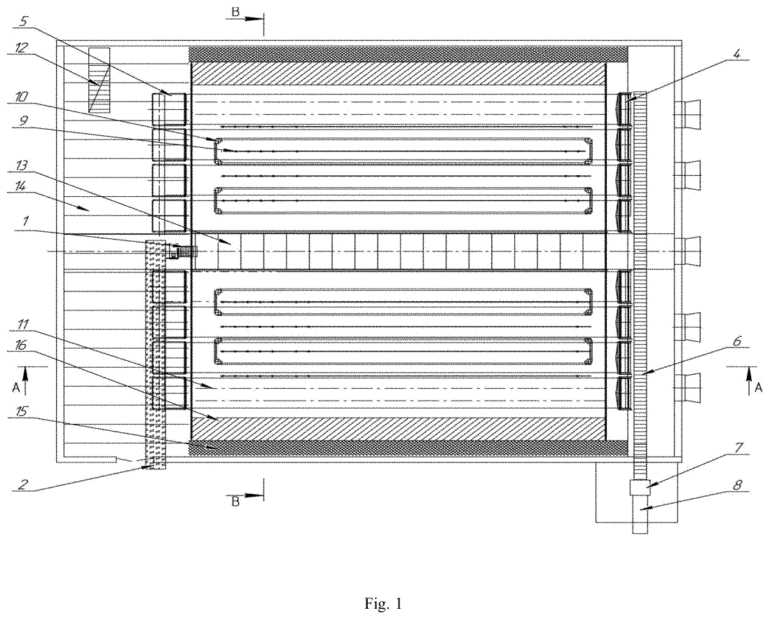

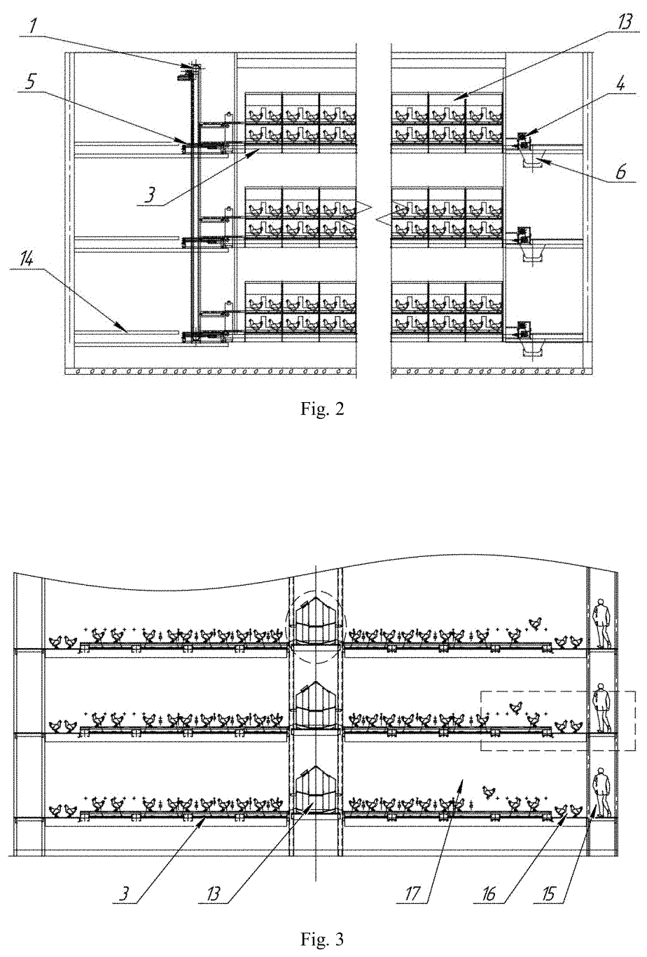

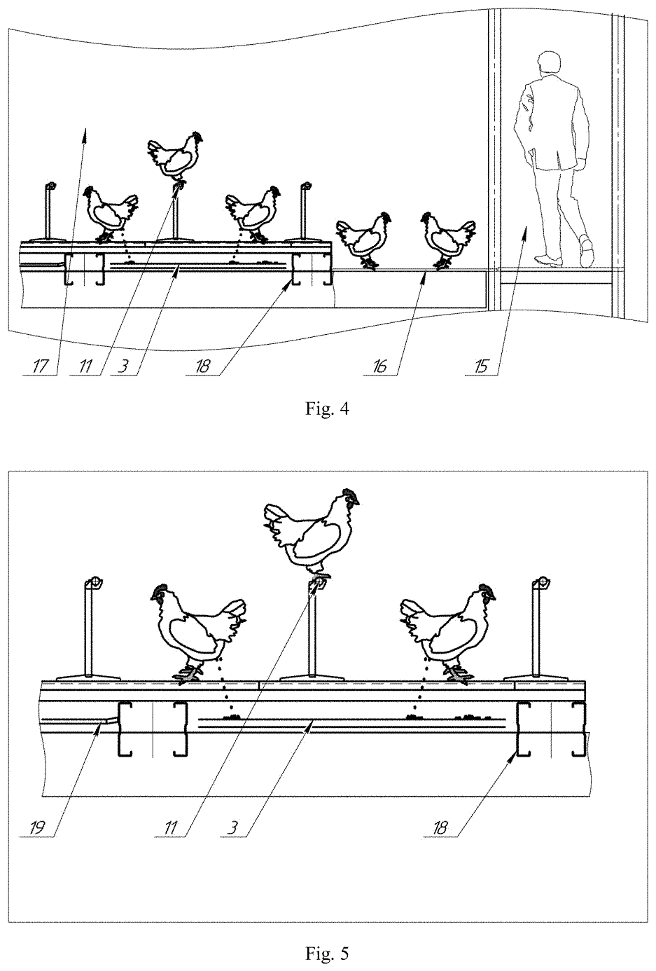

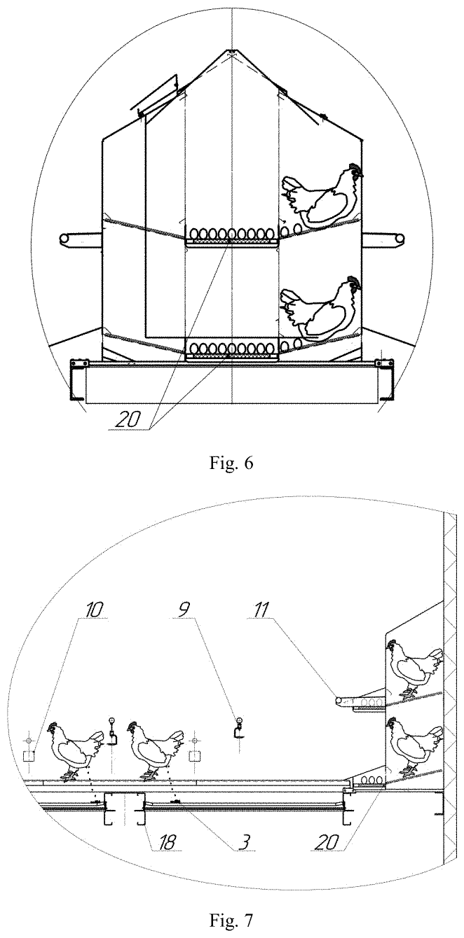

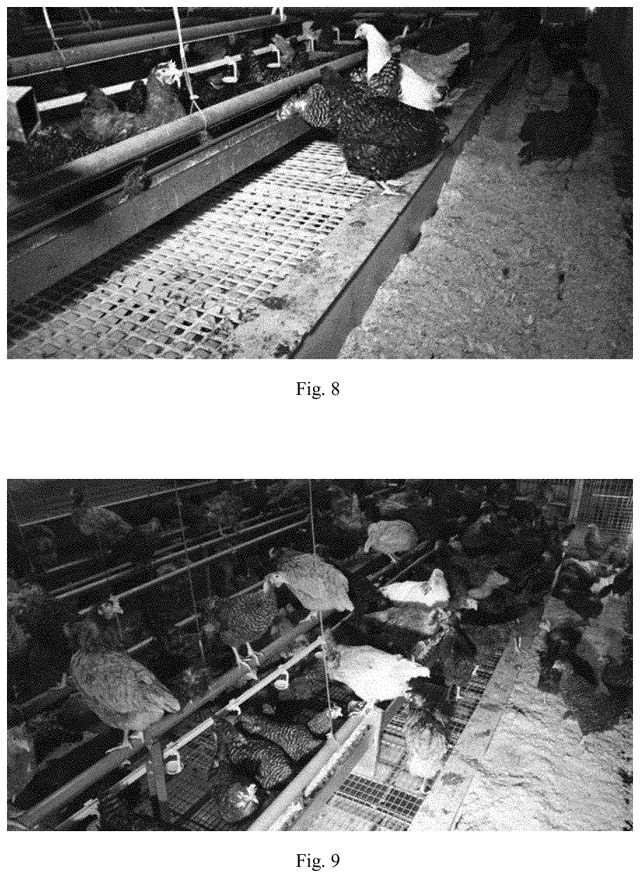

All the levels in the aviary fitted with EGGOIST equipment system are the same, apart from the bottom level, where extra production equipment is installed. The level where the life cycle of laying hens takes place represents an aviary with guards and a mesh floor. The arrangement of a separate level is illustrated in FIG. 1. The elevator 1 accumulates and collects all the eggs laid by the hens in the nests located within one level and further passes them to the cross collecting transporter 2 positioned at the first level in the frontal part of the aviary construction and intended for transporting the eggs outside the aviary for further processing, grading and packing. The manure removal transporter belt 3 (designated on FIG. 2 and FIG. 3) runs along the whole level. The belt 3 is positioned in several longitudinal rows, spanning the whole level on a certain distance below the level of the wire mesh floor, and is operated by a motor-drive manure removal station 4, which is positioned inside on each level at the backside of the construction. Besides, the manure removal belt 3 is connected with the manure removal belt tensioner 5 positioned on each level in the frontal part of the construction and ensuring the required tension of the belt 3, preventing it from sagging down under the weight of the collected manure. The motor-drive station 4 and the manure removal belt tensioner 5 are interconnected by belt 3. The manure removal belt 3 can be cleaned with any required frequency. As the belt 3 moves, it discards the manure on the horizontal manure removal transporter 6 intended for transporting the manure beyond the level to the manure chuting shaft 7. A horizontal strip—“cleaner”—is positioned in front of the motor-drive manure removal station 4 across the width of the belt 3 to scrape the manure residues stuck to the belt and discard them to the transporter 6. Horizontal transporter 6 is positioned inside on each level at the backside of the construction. The manure chuting shaft 7 is intended for collecting manure from all levels and passing it to the sloping manure removal transporter 8 positioned outside at the backside of the construction and transporting manure beyond the aviary. The drinking line 9 and the feeding line 10—the groups of mechanisms intended for providing the birds with the necessary quantity of water and feed respectively—are positioned on each level within direct and easy access for the birds. The feeding line is designed as looped feeding systems positioned on each level. The number of loops of the feeding lines is calculated based on the regulatory feeder space per bird depending on the poultry stock. The feeding and drinking are automated. The feed is dispensed and delivered from the bulk bin by pouring out and its control is programmed in accordance with the feeding norms. For the ease of servicing the facilities of the level, the drinking 9 and feeding 10 systems can be hoisted to the ceiling on wire ropes. Also, the perches 11 (designated on FIG. 4 and FIG. 5) are directly and easily accessible for the birds on each level. The levels are connected by a ladder 12. The nesting zone 13 intended for laying eggs is positioned along the longitudinal axis in direct access for the birds. It is constructed as a cluster of comfortable nests of a special structure. A nest (FIG. 6) may be one-, two- or three-tiered. The construction of the nest allows capturing the laid egg immediately and directing it by the belt transporter—egg collector 20 (designated on FIG. 6, FIG. 7) onto the elevator 1. The nests are equipped with the system of night-time expeller, so that the birds would not hide in them, but would go to sleep on the perches.

The frontal service zone for the personnel 14 (separately indicated on FIG. 2) and longitudinal service zones (so called “lateral galleries”) 15 (indicated on FIG. 3 and FIG. 4) are positioned along the perimeter of the aviary body frame on each level to arrange of auxiliary mechanisms and to be used as service walkways. They are fitted with entrances into the aviary pens for the convenience of the personnel operating and maintaining the equipment and periodically inspecting the state of the birds. Along the whole level, adjacent to the side galleries 15 is the natural needs zone 16, intended for the satisfaction of laying hens' natural physiological needs in scratching the ground with the paw to look for food. In the natural fitter area taking 15 to 30% of the total floor area, the wire mesh floor is covered by a solid covering with sawdust litter. The birds spend most of their life cycle in the main housing zone 17 which occupies the largest part of the total level area and is situated along its longitudinal axis between the natural needs zone 16 and the nesting zone 13. The mutual arrangement of zones 13, 15, 16 and 17 is shown in FIG. 3.

As FIG. 5 shows, manure, feed residues and other waste products in the main housing zone 17 are trampled down by the hens through the mesh floor and land in the manure removal system, which maximally reduces the poultry's contact with aggressive environment. In the natural needs zone 16, which is not trampled, a regular scraper cleaning system may be used, with scrapers oriented in one plane with the manure removal belt 3 for partial manure collection and moving it on the manure removal belt. Such intensive cleaning significantly improves the microclimate in the aviary. The main housing area 17 may be partitioned by mesh walls into separate modules for equal distribution of the birds throughout the level, usually on the basis of 2000 birds per pen. The distance between the partitions, i.e. the length of the module, may vary at the discretion of the customer (egg producer) subject to the industry standards of the floor space for birds. FIG. 5 also illustrates the bearing members of the aviary construction: the support sigma-profile 18, upon which the floor for the birds lies in zone 16 and other production equipment is mounted, and the manure removal belt support beam 19, which protects the belt from sagging down.

FIG. 6 demonstrates a two-tier nest in section with an egg collector 20 positioned inside along the longitudinal axis of the aviary.

FIG. 1 demonstrates a version of a level arrangement, when the egg collector is positioned inside the nesting area and occupies a part of its space along the longitudinal axis of the aviary, and the servicing zone is positioned on the left and on the right along the perimeter. In this version a double nest opening to both sides is used, as is shown on FIG. 6, and the servicing of the aviary is possible with maximum comfort.

The main area of poultry housing 17, the natural needs area 16, as well as the nesting area 13 combined constitute the zone of poultry housing in the aviary fitted with EGGOIST floor equipment system. Under the European standards, a usable area of the aviary is only the area where the birds are actually housed, i.e. cages or aviaries, including the feeding and drinking systems, as well as perches for night rest. The nesting areas are not considered to be usable space. The areas of auxiliary equipment location, service walkways and service zones which, in effect, merely provide extra utilities, are not considered to be usable areas either. At the same time, a general tendency towards increasing the part of the usable area in aviaries is observed. Considering this, EGGOIST multi-tier floor equipment system may be embodied in a number of ways. For example, the longitudinal service zones (lateral galleries) may be minimized across the width or obviated altogether at the discretion of the customer. It is technically possible to position the egg collector against the wall of the aviary guard. In this case it is covered by a protective screen, so that the birds could not peck the eggs, and the area used for egg collectors becomes usable, as it becomes possible to place the perches for the birds' night rest beneath them. Single nests with one entrance as shown in FIG. 7 are used for this embodiment. The longitudinal service zone in this case is absent or positioned inside along the longitudinal axis of the aviary body frame.

FIG. 8 and FIG. 9 demonstrate the boundary between the main area of poultry location (left) and the natural needs zone (right), and a fragment of one of the levels of the aviary fitted with EGGOIST equipment system.

The support sigma-profile and the manure removal belt support beams reinforce the construction of the aviaries fitted with EGGOIST multi-level system of equipment, whereby the mesh floors for the poultry act as floors between the levels. The absence of solid flooring in the construction enables to speed up the erection and cut its cost.

A better embodiment of the invention consists in the construction of an aviary fitted with EGGOIST multi-level equipment system, with optimum dimensions of the of the aviary body frame calculated as per the formulae specially developed to ensure absolute compliance of the useable area of the construction to the norms of cage-free poultry maintenance.

The length of the aviary body frame as a whole is determined by the total number of the birds to be kept in it, and the norms of the floor space per bird, while the length of the poultry housing zone must be a multiple of the feeding front. Thus, the length A of the aviary body frame in meters is calculated as

A=TFₖ/4k+P+H (1)

for the option of single nests positioned against the walls of the aviary guards, and

A=TFₖ/8k+P+H (2)

for double nests positioned in the middle of the nesting area.

Conventions:

T—number of birds;

k—the coefficient which takes into account the tiering of the nest (one, two or three tiers);

Fₖ—regulatory feeder space per bird, m;

P—the length of the area of the motor-drive manure removal stations location;

H—the length of the area of the manure removal belt tensioner and egg collector location.

The value of parameters P and H is conditioned by the technological necessity. In this case, P=2.5 m, and H=5 m. When necessary, these dimensions may be altered within certain limits without failing to comply with the standards of equipment operation in terms of area accepted in Ukraine (the minimum distance from the poultry housing area to the motor-drive station is 1.500 m), as well as the ones established by the EU Directive 98/58/EC (0.900 m) and the guidelines of the US poultry farming associations (0.798 m.). Thus, the exact value of parameters P and H is determined by the specific conditions of the equipment layout and the customer's wishes, subject to the standards applicable in the given country.

The width B of the aviary body frame in meters depends on the position and tiering of the nests and is calculated using the following formula:

B=4(kS_{H}+Sₚ)/Fₖ+Bₒ+Bᵢ

in the case when single nests are positioned against the wall of the aviary guard, and

B=8(kS_{H}+Sₚ)/Fₖ+Bₒ+Bᵢ

in the case when the nests are double and positioned along the longitudinal axis of the nesting area and, correspondingly, the aviary body frame.

Conventions:

Sₙ—regulatory space per bird, m²;

Sₚ—regulatory nest area per bird, m²;

bₒ—the width of the longitudinal service zone, m; for double nests, values Bₒ on the left and on the right are summarized;

bᵢ—the extra width of the nest, m; depends on the position and the width of the egg collector belt.

The optimum usable depth of the nest in meters is calculated as L=4Sₚ/Fₖ for single nests with one entrance positioned against the wall of the aviary guards, and L=8Sₚ/Fₖ for double nests positioned along the longitudinal axis of the nesting area and having two entrances.

The use of EGGOIST multi-level system of equipment substantially decreases the labor efforts on servicing the aviary. For example, at the manufacturing and experimental plot of TEXHA Production Association (Novohrad-Volynsky, Zhytomyr region) in a standard floor aviary with the area of 1,600 m2 (at the rate of 5 birds per 1 m2) serviced by one farm laborer, up to 8,000 laying hens are usually kept. A three-level aviary fitted with EGGOIST equipment having the same usable area of one level (floor) is also serviced by one regular worker and by a part-time technician; while the aviary contains 24,000 birds, i.e. three times as much. A worker attends to all three levels in eight hours per day, a technician—in two hours per day; thus in a full-time working day a technician can enable the operation of 3 to 4 aviaries, i.e. service over 70,000 hens.

EGGOIST multi-level floor equipment system for commercial poultry maintenance fully complies with the norms set by EU Council Directives 98/58/EC and 1999/74/EC, as well as the guidelines and requirements for cage-free poultry maintenance set by professional US poultry breeder associations: HFAC (Human Farm Animal Care) and UEP (United Egg Producers), as well as AHA (American Humane Association) implementing the foodstuff certification program AHC (American Humane Certified™—Humane Heartland™ Farm Animal Program).

A practical test of the functionality and advantages of EGGOIST multi-level system of floor equipment was conducted in 2016-2017 at the premises of the manufacturing and experimental plot of TEXHA Production Association (Novohrad-Volynsky, Zhytomyr region). A comparative study of two systems of poultry housing equipment: BALTIKA equipment for caging poultry with poultry run for 21,500 hens and EGGOIST multi-level system of floor equipment for 7,500 hens, was undertaken. Both kinds of equipment are manufactured by TEXHA Production Association. Laying hens of LohmannBraun (brown) and LohmanSLClassik (white) hybrids were chosen as study material. During the study, the following was considered: hens' egg production (egg-laying curve) and body weight dynamics, safety of adult birds, commercial properties of the eggs (egg weight, cracks, and shell quality). The results of the study are presented in the tables.

The data of Table 1 gives an overview of the birds' performing characteristics when different floor housing systems were used in comparison with the established standard for the strain, and assess the efficiency of the existing housing methods. It has been established that the birds housed with the use of EGGOIST equipment system equal the standard parameters for LohmannBraun (LB) strain in their performing characteristics and even exceed the functional indicators of the birds housed with the use of BALTIKA equipment.

TABLE 1
Comparative analysis of laying hens' performance

| Index | LB standard | BALTIKA | EGGOIST |
|---|---|---|---|
| Age at 50% laying of eggs, weeks | 21 | 20.5 | 21.5 |
| Egg-laying peak, weeks | 30 | 29 | 31 |
| Peak height, % | 92-94 | 93.2 | 96.3 |
| Egg production per bird, eggs | 305-315 | 301 | 312 |
| Average egg weight, g | 63.5-64.5 | 63.6 | 64 |
| Liveability in 78 weeks of life, % | 94-96 | 95.2 | 96.2 |

It is worth mentioning that the dynamics of egg production of the hens housed with various equipment systems differed in a number of ways. The analysis of separate segments of the curve of egg production shows birds' response to the housing conditions at a certain age. The adaptation of the young stock to the housing conditions also took place with certain peculiarities. The analysis of the body weight dynamics during the adaptation period may lead to the conclusion that the young stock in the EGGOIST system settled faster and better than the others.

TABLE 2
Body weight dynamics of laying hens in different periods of egg
production

| | Average body weight of the | | |
|---|---|---|---|
| | birds in different ages, g/% | | |
| Housing conditions | 19 weeks | Egg-laying peak | 52 weeks |
| Standard LB | 1583/100 | 1923/100 | 1975/100 |
| EGGOIST | 1810/114 | 1920/99.8 | 2030/103 |
| BALTIKA | 1780/112 | 1920/99.8 | 1940/98 |

Table 2 data demonstrate that the birds kept in the active movement conditions with the use of EGGOIST system of equipment meets the strain standard at the end of the maintaining period, and does not differ significantly from the standard by the body weight values. Thus, the average body weight of 19-week old rearing stock was higher than the one of the young stock of the same age housed with the use of BALTIKA equipment. This attests to the fact that the young stock introduced into the grown-up flock at 17 weeks under the EGGOIST housing conditions, adapts quicker and better than under aviary housing.

The birds' liveability is considerably high and meets the standard (94-99%). The analysis of the liveability data in different housing conditions showed that the hens' safety rates were the highest when EGGOIST equipment system was used, which is illustrative of the birds' viability maintained by a increased metabolism due to high motor activity.

The efficiency of the use of birds is determined not only by their egg production, but also by the quality of the produce. The study of the eggs laid by 30-week old hens (at the egg-laying peak) under different housing conditions showed that the hens kept in the EGGOIST system laid larger eggs: on average 1.9 g heavier than the hens kept with the use of BALTIKA equipment and 1.2 g heavier than the strain standard establishes. This tendency persists in the hens' later life, at 52 weeks. The comparative analysis of biophysical properties of the eggs, which determine their market value, demonstrated that the hens kept with the use of EGGOIST equipment system laid eggs with a higher content of dry matter in the egg white, and a thick hard shell.

The distribution analysis of the eggs with dirty or damaged shell produced by hens under different housing conditions showed that when the birds were kept with the use of EGGOIST equipment system, 9% of eggs with dirty and 1% of eggs with damaged shell were produced. For the hens housed with the use of BALTIKA equipment these figures were 24% and 2% respectively.

The studies have established that the rate of egg production of the hens in an aviary fitted with EGGOIST equipment system was higher throughout the whole production cycle, had a higher peak and stable performance. In comparison with aviary poultry housing utilizing BALTIKA equipment system, EGGOIST ensures a longer productive period—from 17 to 100 weeks, a larger number of eggs per laying hen, improved feed conversion rate and a better poultry liveability, with approximately a three-fold reduction of floor eggs.

TABLE 3
Technical results of the hens in different housing systems

| Index | EGGOIST | BALTIKA |
|---|---|---|
| Production cycle, days | 385 | 375 |
| Number of eggs per 1 laying hen, eggs | 316 | 302 |
| Feed conversion rate, feed per kilogram of | 2.25 . . . 2.32 | 2.39 |
| eggs | | |
| Feed consumption, gram per bird per day | 120 . . . 124 | 127 |
| Mortality, % | 8 | 11 |
| Number of floor eggs, % | 3 . . . 5 | 10 . . . 15 |

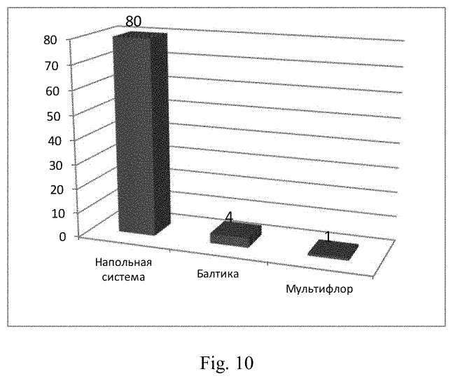

FIG. 10 diagram presents the results of the study of the rates of infestation of laying hens by helminthes when using various systems for poultry maintenance. Three groups of laying hens of the same age and hybrid, 100 birds in each, were formed for the comparative analysis. The first group was placed into the standard floor housing conditions, the second—in an aviary fitted with BALTIKA equipment system, and the third—in an aviary fitted with EGGOIST equipment system. All birds were housed in the above-mentioned conditions during 50 weeks, whereupon the intestines of the birds of each group were studied. The level of parasitic infestation was measured by Darling's method of laboratory testing. The study findings allowed to establish that infestation by helminthes and protozoa (Eimeira) was diagnosed in 79 birds in the first group and in 4 birds in the second group; only one bird was infested in the third group. Thus, housing the birds with the use of EGGOIST equipment system allows to decrease the rates of stock infestation by helminthes, lowering this figure to ≤1%. EGGOIST multi-level floor equipment system ensures the absence of constant contact of the birds with manure which usually gets from the birds' paws into feeders, drinkers, nests and perches, causing infestations in the stock. Thus, the source of infestation is eliminated and the hens cease to be helminthes carriers.

The studies have proved the efficiency of EGGOIST multi-level floor equipment system for the production of quality produce. In comparison with the conventional floor housing of the birds, this system is characterized by its ease of maintenance and ease of access to the birds and equipment by the personnel. Egg collection, logistics and supplying water and feed to the aviary is simplified. The microclimate conditions and lighting regimes are adjusted by the remote control positioned at the bottom level. The ventilating equipment ensures the optimum distribution of air flows and maintenance of the preset air temperature and humidity on each level independently. Due to the high mechanization and automation level of the processes, a minimal number of personnel is required to service the aviary; also, manual labor costs are virtually eliminated. Housing the birds with the use of EGGOIST equipment system is maximally approximated to their natural living environment and allows to satisfy the physiological needs of laying hens. The bird morbidity and injury rate decreases substantially. When the floor housing of poultry is actually used, EGGOIST multi-level floor equipment system dramatically increases the production rates per farmland area unit. With corresponding variation of the production cycle parameters it can be used for growing the young stock to the required conditions. EGGOIST equipment system is intended mostly for specialized farms.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. EGGOIST multi-level system of floor equipment for commercial maintenance of egg-laying hens, each level of which consists, in particular, of the main poultry housing area, nesting area with an egg collector, service areas of drink and feeding systems, manure removal system, as well as a number of auxiliary mechanisms, wherein the floor of each of the levels is designed as a wire mesh, and the manure removal system includes a transporter whose belt is positioned below the level of the mesh floor.

2. EGGOIST multilevel floor equipment system of claim 1, further comprising poultry's natural need zones with solid floor covering taking 15 to 30% of the total floor area of each level.

3. EGGOIST multi-level floor equipment system of claim 1, wherein the construction of the aviary and equipment installation are conducted simultaneously, whereby separate parts of the equipment serve as bearing members of the building structure.

4. EGGOIST multi-level floor equipment system of claim 1, wherein the optimum dimensions of the aviary body frame are calculated as per special formulae for the length and width depending on the nest type and arrangement.
